(19) United States
(12) Patent Application Publication
(10) Pub. No.: US 2024/0013191 A1
(43) Pub. Date: Jan. 11, 2024

(54) Venue Item Ordering and Delivery Application, System, and Method

(71) Applicant: Candice Alexander, Harvest, AL (US)

(72) Inventor: Candice Alexander, Harvest, AL (US)

(21) Appl. No.: 18/153,429

(22) Filed: Jan. 12, 2023

Related U.S. Application Data
(60) Provisional application No. 63/359,466, filed on Jul. 8, 2022.

(51) Int. Cl. G06Q 20/32; G06Q 20/38; G06Q 30/0601; G06F 3/0482

(52) U.S. Cl. CPC G06Q 20/3267; G06Q 20/3821; G06Q 20/389; G06Q 30/0631; G06F 3/0482

(57) ABSTRACT

The present invention relates to a novel software application for enabling users to select a vendor at a venue, select menu items for order, pay for selected menu items, and pick up menu items at an ‘express’ lane or potentially have them delivered to their seats. The software application is configured to display a digital map showing location of all the vendors at a venue and real-time order status to users. In some embodiments, the application communicates with a server for sending order details and receiving real-time order status. The menu can be displayed in the application upon selection of a vendor or alternatively upon scanning of a QR code of a vendor. The application and associated method and system prevent individuals from missing out on important highlights and moments at an event because of the obviation of waiting in line for food and drinks.

### CROSS-REFERENCE TO RELATED APPLICATION

The present application claims priority to, and the benefit of, U.S. Provisional Application No. 63/359,466, which was filed on Jul. 8, 2022, and is incorporated herein by reference in its entirety.

### FIELD OF THE INVENTION

The present invention relates generally to the field of e-commerce and in-venue items ordering and delivery. More specifically, the present invention relates to a software application designed for customers at stadiums and arenas, enabling them to place mobile orders at concession stands. The application enables users to quickly place and pay for food and beverage orders, then retrieve them all without waiting in long lines. The application prevents individuals from missing out on important event highlights and moments by eliminating standing in long queues. Accordingly, the present disclosure makes specific reference thereto. Nonetheless, it is to be appreciated that aspects of the present invention are also equally applicable to other like applications, devices, and methods of manufacture.

### BACKGROUND

By way of background, food, drinks, snacks, and other items are commonly sold at concession stands at a theater, stadium, conventions, social events, sporting events, and more. A concession stand or snack kiosk is a place where patrons can purchase the desired items. Concession stands are located at different locations at a venue and sales of food, beverages, and merchandise at these concession stands presents a sizable source of revenue, fun, and comfort for crowd. Individuals often need to leave their seats and go to a concession stand for purchasing one or more items. As a result, long queues are a common sight at concession stands due to which individuals may end up missing important parts of the events/sports. Research studies have shown that long queues at concession stands have reduced satisfaction of fan experience and many individuals give up waiting in line for food, drinks, and more at a venue. This also leads to loss of business for sellers and loss of revenue. Unmanaged crowds near the concession stand(s) may cause unexpected trouble to children and elderly individuals standing in proximity thereto.

Modern vending machines dispensing food and beverages are also not able to reduce the lines at kiosks at venues and individuals may have to wait for the vending machines to replenish. Vendors physically selling items in the crowd is also an ineffective approach as it requires a lot of manpower and is expensive. Further, there is a risk of items spilling down to the ground or on the crowd.

For providing improved fan experience and improved sales of food, beverages, merchandise, and more so that the users can quickly and easily purchase items, an improved method is desired by both venue authorities and attendees.

Therefore, there exists a long-felt need in the art for a way to reduce long queues at concession stands at venues. There is also a long-felt need in the art to improve food, beverages, and merchandise delivery from concession stands at sporting events/stadiums and other venues. Additionally, there is a long-felt need in the art to enable individuals to purchase items at a venue from their seat. Moreover, there is a long-felt need in the art to improve sales at concession stands by reducing time spent by individuals in queues and physically purchasing the items from concession stands. Further, there is a long-felt need in the art for quicker ways to get food, drinks, and merchandise at concession stands. Furthermore, there is a long-felt need in the art for a system that enables individuals to preview items, prices, and brands before purchasing items from concession stands. Finally, there is a long-felt need in the art to prevent individuals from missing out on important highlights and moments at an event because they were waiting in line for food and drinks.

The subject matter disclosed and claimed herein, in one embodiment thereof, comprises a computer implemented method for placing food and beverage orders at a venue, arena, and the like using a smartphone application. The application enables customers to quickly place orders, pay for the orders, and collect the ordered items quickly. The method comprising the steps of displaying, by the smartphone application, vendors located at a venue in the form of a digital map; receiving, by the smartphone application, a selection of a vendor from a user; displaying, by the smartphone application, food and beverage menu of the selected vendor; receiving, by the smartphone application, a selection of one or more items from the menu; receiving, by the smartphone application, payment for selected one or more items; displaying, by the smartphone application, real time order status of the items.

In this manner, the software application of the present invention accomplishes all of the forgoing objectives and provides users with a software application designed for customers at stadiums and arenas, enabling them to place mobile orders at concession stands. Customers can order items from their seat without physically going to vendors or concession stands and pick the items up at an ‘express’ lane for mobile orders or alternatively have them delivered to their seats. The present invention prevents individuals from missing out on important highlights and moments at an event because they were waiting in line for food and drinks.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a method for placing food and beverage orders and paying for the ordered items using a smartphone application. The method comprising the steps of displaying, by the smartphone application, concession stands located at a venue in the form of a digital map; receiving, by the smartphone application, a selection of a concession stand from a user; displaying, by the smartphone application, food and beverage menu of the selected concession stand; receiving, by the smartphone application, a selection of one or more items from the menu; receiving, by the smartphone application, payment for selected one or more items; displaying, by the smartphone application, real time order status of the items; and, displaying, by the smartphone application, a notification when the order is ready for pick-up or delivery.

The subject matter disclosed and claimed herein, in one embodiment thereof, comprises a method of ordering items at a venue from a seat without physically going to a concession stand. The method comprising the steps of displaying locations of the various vendors at the venue in the form of a digital map; displaying menu items of the vendors for selection by a user; receiving payment and delivery options from the user; displaying real time order status information; and, alerting the user when the order is ready to be delivered or to be picked up.

In another aspect of the present invention, a non-transitory computer-readable medium storing instructions which, when executed by one or more processors of an electronic device, cause the electronic device to: display a map showing different vendors or concession stands, the vendors are located at a venue whose location is detected by the electronic device; display menu of a vendor wherein the menu is displayed upon scanning of a machine readable code such as a QR code; display real time order status and delivery instructions upon completion of the order.

In yet another embodiment, the present invention provides coordination of an express line for picking up ordered items quickly.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a flow diagram showing a process of ordering foods, beverages, and more quickly using the concession stand food ordering smartphone application of the present invention in accordance with the disclosed architecture;

FIG. 2 illustrates a schematic view showing the in-venue items ordering and delivering system of the present invention used for ordering and delivering items in accordance with the disclosed architecture;

FIG. 3 illustrates an exemplary user interface of the smartphone application for enabling a user to enter the application for ordering different items in accordance with the disclosed architecture;

FIG. 4 illustrates a home screen displayed by the mobile concession stand smartphone application to a user in accordance with the disclosed architecture;

FIG. 5 illustrates another exemplary user interface showing the menu of a selected concession stand displayed by the smartphone application of the present invention in accordance with the disclosed architecture;

FIG. 6 illustrates another embodiment of displaying menu items of concession stands by the food and beverage ordering smartphone application of the present invention in accordance with the disclosed architecture;

FIG. 7 illustrates yet another user interface enabling a user to pay for the selected items for completing an order using the mobile concession stand smartphone application in accordance with the disclosed architecture;

FIGS. 8A and 8B illustrate different options of order delivery offered to the users by the system in accordance with the disclosed architecture;

FIG. 9 illustrates an express pick-up option provided by the concession stands enrolled in the food order and delivery system of the present invention in accordance with the disclosed architecture;

FIG. 10 illustrates a flow diagram depicting a process of displaying recommendations and coupons to the customers by the smartphone application in accordance with the disclosed architecture; and

FIG. 11 illustrates the exemplary user device that is used for installing the software application of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It can be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments can be combined.

As noted above, there is a long-felt need in the art for a way to reduce long queues at concession stands at venues. There is also a long-felt need in the art to improve food, beverages, and merchandise delivery from concession stands at sporting events and other venues. Additionally, there is a long-felt need in the art to enable individuals to purchase items at a venue from their seat. Moreover, there is a long-felt need in the art to improve sales at concession stands by reducing time spent by individuals in queues and physically purchasing the items from concession stands. Further, there is a long-felt need in the art for quicker ways to get food, drinks, and merchandise at concession stands. Furthermore, there is a long-felt need in the art for a system that enables individuals to preview items, prices, and brands before purchasing items from concession stands. Finally, there is a long-felt need in the art to prevent individuals from missing out on important highlights and moments at an event because they were waiting in line for food and drinks.

The present invention, in one exemplary embodiment, is a non-transitory computer-readable medium storing instructions which, when executed by one or more processors of an electronic device, cause the electronic device to: display a map showing different vendors or concession stands, the vendors are located at a venue whose location is detected by the electronic device; display a menu of a vendor wherein the menu is displayed upon scanning of a machine readable code such as a QR code; display real time order status and delivery instructions upon completion of the order.

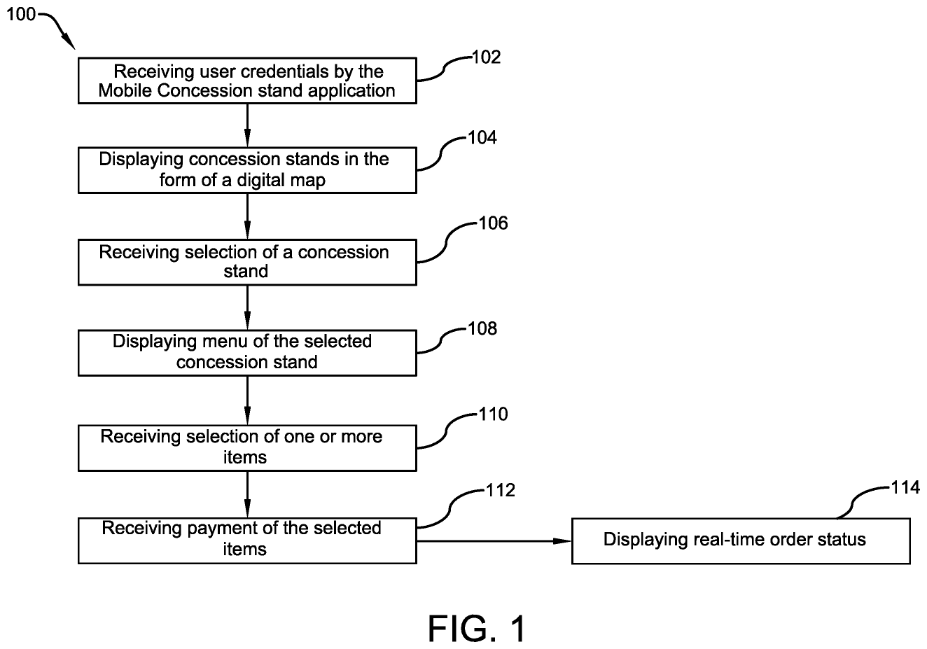

Referring initially to the drawings, FIG. 1 illustrates a flow diagram showing a process 100 of ordering foods, beverages, and more quickly using the concession stand food ordering smartphone application of the present invention in accordance with the disclosed architecture. Initially, user credentials including, but not limited to, user ID and password of a user are received by the smartphone application 202 (Step 102). A user registers on the application 202 for generating a password and then logs into the application 202 for ordering items. Once, the user is successfully authenticated, then, a digital map showing different concession stands positioned at the venue is displayed by the smartphone application 202 (Step 104). It should be noted that based on the current location of the user (i.e., seat section) and the proximity of concession stands of a specific venue, a digital map is shown by the concession stand smartphone application 202 that displays concession stands that are close in proximity (i.e., proximal or near) to the user and the user's seat section.

Selection of a concession stand from the displayed concession stands is received by the smartphone application 202 (Step 106). The smartphone application 202 is configured to display name, logo, and location of concession stands on the digital map enabling a user to easily identify a concession stand for selection. Once, a concession stand is selected by the user, a menu along with pictures, prices, and more are displayed of the selected concession stand (Step 108). For displaying the menu of the concession stand, a QR code provided by the concession stand can be scanned enabling the smartphone application to display the menu of the concession stand.

For easy and convenient ordering, without physically going to the selected concession stand, one or more food items, beverages, and more are selected by the user and the selection is received by the smartphone application 202 (Step 110). After receiving the selection, successful payment is captured by the smartphone application 202, and a successful order is notified (i.e., confirmed) to the user (Step 112). Upon a successful order, the real-time status of the placed order is displayed by the smartphone application (Step 114) and accordingly, the smartphone application prevents individuals from missing out on important highlights and moments at an event by enabling them to order from their seat.

In some embodiments of the present invention, the ordered items are delivered to the seat by the concession stand to the which the order is placed or alternatively, in some embodiments, the ordered items are picked up by the user who placed the order through an express line thereby reducing the time spent in conventional queues at concession stands. It should be appreciated that the orders placed by individuals using the concession stand food ordering application are received by vendors deploying the concession stands and the orders are delivered only once payment is successful.

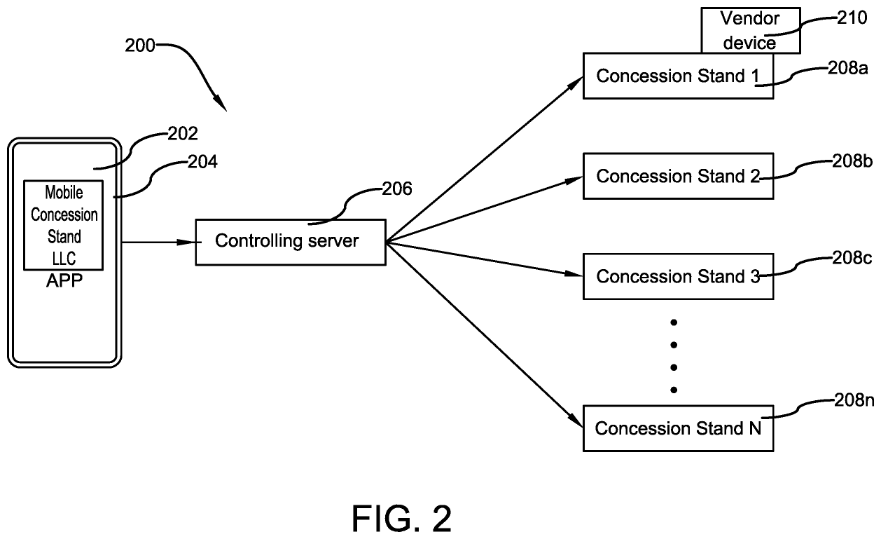

FIG. 2 illustrates a schematic view showing the in-venue items ordering and delivering system of the present invention used for ordering and delivering items in accordance with the disclosed architecture. The system 200 enables the users to order items including, but not limited to, food, beverages, merchandise, and more using the mobile concession stand application 202. The application 202 can be installed in an electronic device 204 such as a smartphone, smartwatch, tablet, PDA, or any other conventional electronic device. The system 200 is preferably used inside a venue such as a sports arena, stadium, theater, concert hall, and more where users purchase items from different concession stands located in the venue.

In the present embodiment, a controlling server 206 which is a local server for a specific venue controls the orders placed by the users. The server 206 is also coupled to different concession stands located in the venue such that the orders placed by users are notified to specific concession stands 208a-n. The application 202 communicates with the server 206 using a wireless communication channel or network. The wireless channel can be associated with a data standard which can be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

In some embodiments of the present invention, the controlling server 206 can be a central server that controls and manages a plurality of venues. Authentication of the user before accessing the smartphone application 202 can be performed by the server 206 or alternatively, can be performed by a separate identity management server (not shown) in different embodiments. The system 200 may provide a vendor device 210 (shown exemplary for 208a) for each concession stand enabling the vendor to view and process the received orders. Real time order and payment information are provided on the vendor device 210 wherein the vendor device 210 can be a fixed device or a portable device in the form of an electronic device.

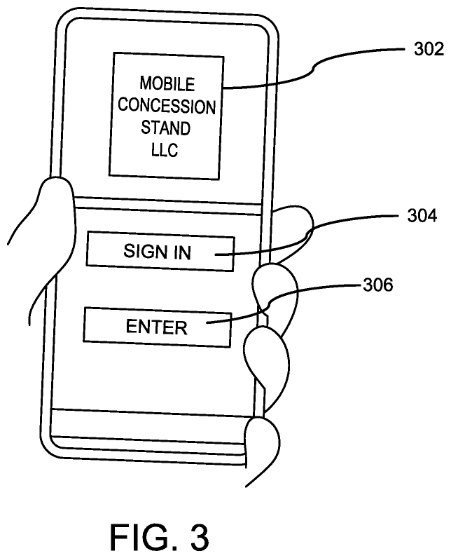

FIG. 3 illustrates an exemplary user interface of the smartphone application for enabling a user to enter the application for ordering different items in accordance with the disclosed architecture. The smartphone application 202 provides a first user interface 302 that enables a user to either sign up using the sign in button 304 or enter the application 202 using the enter button 306. In the present embodiment, before using the application 202, a user signs up on the application 202 by entering personal details such as name, address, contact details, payment details, and more. Additionally, the user can enter favorite venues, vendors, and more as well for enabling the application 202 to recommend items for purchase. Once, a user successfully signs up, the user creates a user ID and a password for enabling the user to directly enter the application 202 using the enter button 306.

In cases where a user enters incorrect user ID or password, then, a notification is displayed on the user interface 302 indicating to the user of unsuccessful authentication. It should be noted that the application 202 enables a user to reset the password based on the preferences of the user.

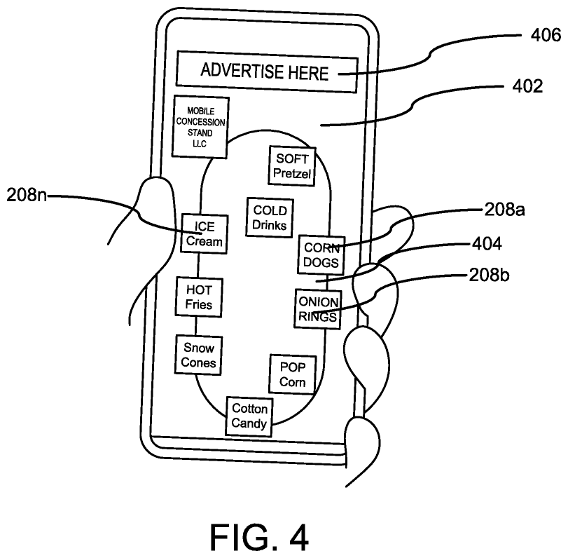

FIG. 4 illustrates a home screen displayed by the mobile concession stand smartphone application to a user in accordance with the disclosed architecture. The home screen 402 displayed by the application 202 is preferably the first screen displayed to a user upon successfully logging into the application. It should be noted that the application detects the venue location using GPS functionality of the electronic device in which the application 202 is installed and accordingly, a digital map 404 showing different concession stands 208a-n located in the venue are displayed on the home screen 402.

The digital map 404 also displays the indoor map of the venue enabling a user to easily reach a specific concession stand. As illustrated, name, location, and other details of the concession stands may also be displayed on the home screen 402. For generating revenue, the home screen 402 displays an advertisement area 406 that can be used for displaying sponsored content for quick access by users and for generating revenue by the system 200.

The digital map 404 may provide a navigation interface, such as for routing a user to one or more concession stands, such as guiding a user through one or more steps. The map 404 may further include providing a visual update of the user on the map as the user moves through the venue and providing a personalized message or other content to the user regarding the venue.

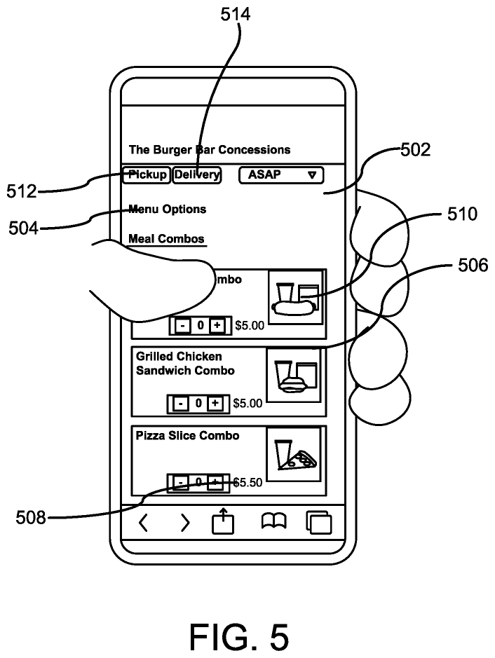

FIG. 5 illustrates another exemplary user interface showing the menu of a selected concession stand displayed by the smartphone application of the present invention in accordance with the disclosed architecture. The smartphone application provides the user interface 502 for displaying menu 504 offered by a concession stand. The concession stand can be selected by the user from the digital map 404 as illustrated in FIG. 4. The menu 504 is dynamic and includes a plurality of items 506 offered by the concession stand along with necessary details such as price 508, pictures 510, and more. One or more items can be selected by the user for placing an order.

It should be noted that the user interface 502 provides the user option of picking up the order from the concession stand through an express line through the Pickup option 512. The vendor may also deliver the ordered items to the seat of the user in case the Delivery option 514 is chosen by the user. In some embodiments, the Delivery option is enabled only for the verified or pre-selectable seats (i.e., seat sections) at the venue. The menu can be updated by the concession stand vendor and is dynamically reflected in the smartphone application. Further, the menu 504 can be divided into a plurality of categories for easy scrolling and selection by a user.

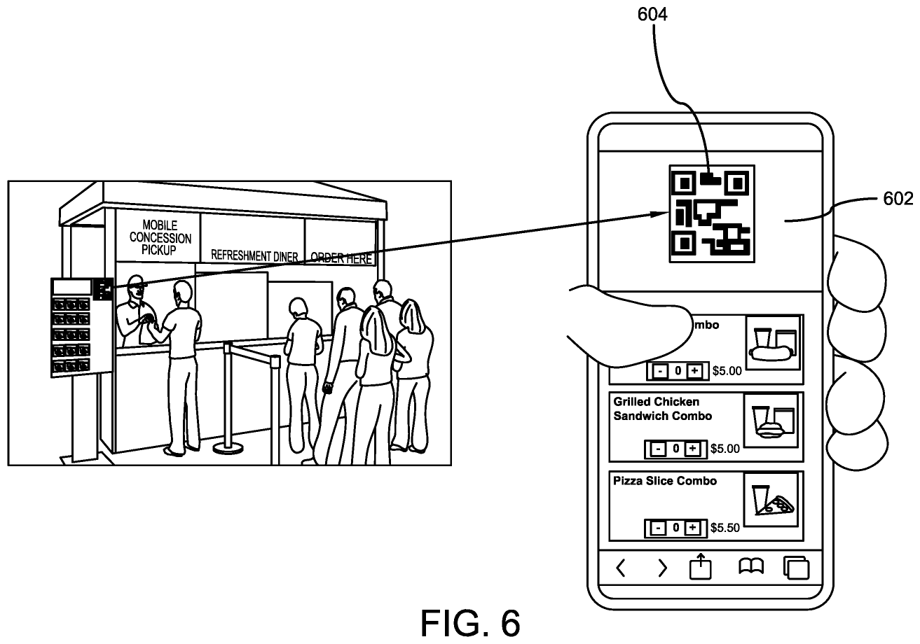

FIG. 6 illustrates another embodiment of displaying menu items of concession stands by the food and beverage ordering smartphone application of the present invention in accordance with the disclosed architecture. In the present embodiment, the menu items of a concession stand are displayed on the user interface 602 of the application 202 upon scanning a QR code 604 positioned on the concession stand 208a. The QR code 604 may also be in the form of a digital QR code and is configured to be scanned by image capturing device of an electronic device.

The QR code 604 once scanned, provides a digital menu similar to that 504 shown in FIG. 5. The user interface 602 may display the brand name, cost, and other details of the concession stand enabling easy identification and selection by a user.

It should be noted that in some embodiments, the vendors may submit a fee to get registered in the system 200 enabling the vendors to receive more customers and increase sales. Further, the theme, color, and design of the different user interfaces provided by the application can be based on the venue and event taking place at the venue.

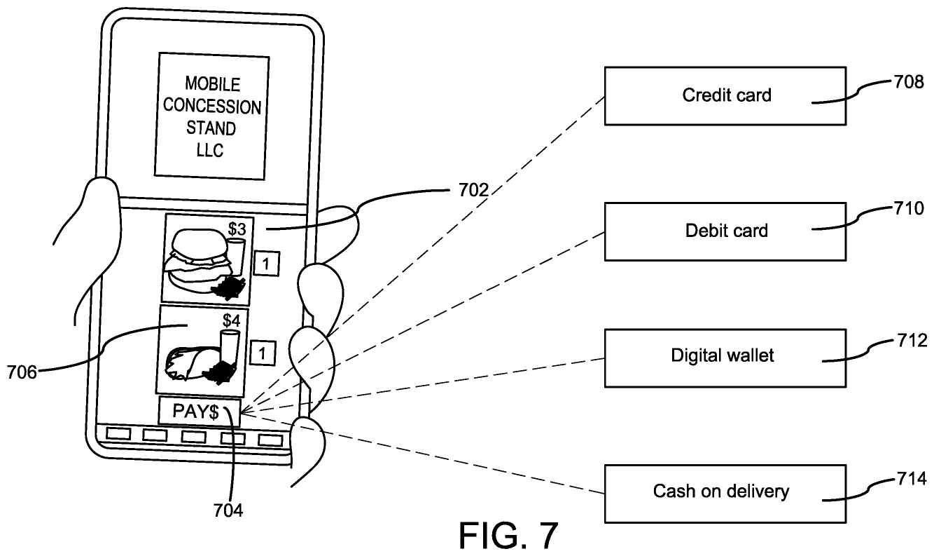

FIG. 7 illustrates yet another user interface enabling a user to pay for the selected items for completing an order using the mobile concession stand smartphone application in accordance with the disclosed architecture. In the present user interface 702, a pay option 704 enables a user to perform payment of the selected items 706. The payment can be done using any known method in the state of the art and includes any payment method discovered or used in the future. As illustrated, a credit card 708, a debit card 710, a digital wallet 712, or cash on delivery option 714 can be selected by a user.

The application 202 enables a user to save one or more cards in the application which is not shared with any third-party and is stored in an encrypted format inside the application 202. Further, the payment may also be processed using third-party payment gateways.

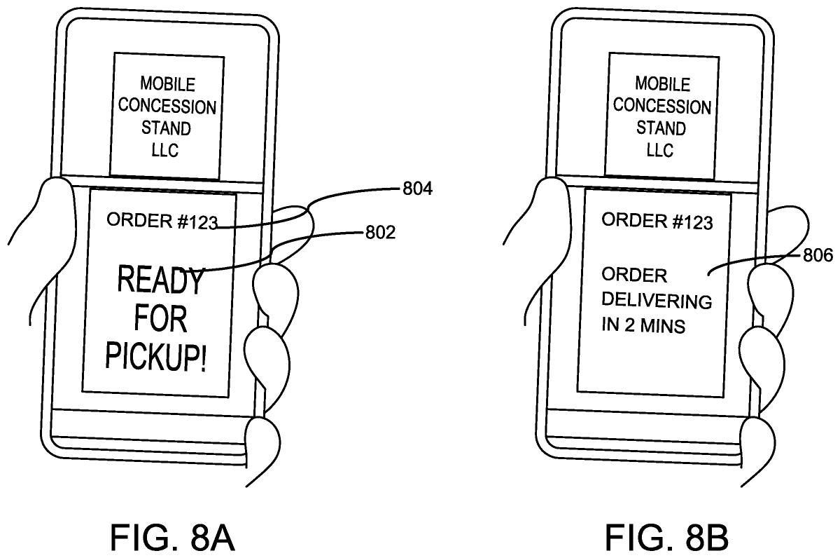

FIGS. 8A and 8B illustrate different options of order delivery offered to the users by the system 200 in accordance with the disclosed architecture. As illustrated in FIG. 8A, if pickup option was selected by a user (as illustrated in FIG. 5), then, real time status of the order showing “Ready for pick-up” 802 along with order number 804 is displayed on the smartphone application. When, delivery option was selected by the user, then, real time status of the order showing “Order delivering in 2 mins” 806 is displayed to the user. It should be noted that in some venues, delivery option can be disabled by venue authorities, disabled by concession stand, and/or limited by seat sections.

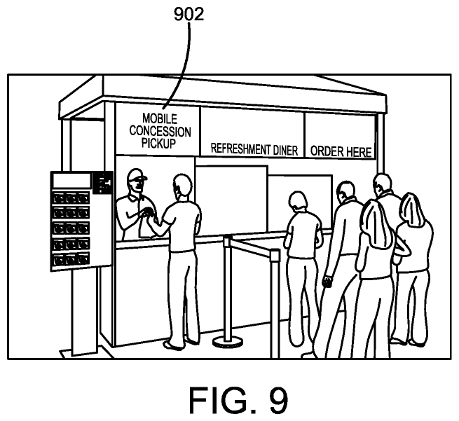

FIG. 9 illustrates an express pick-up option provided by the concession stands enrolled in the food order and delivery system of the present invention in accordance with the disclosed architecture. For reducing time standing in queues and preventing individuals from missing out on important highlights and moments at an event, the concession stands provide an express pick-up and checkout counter 902 for users who are registered to the system 200. A user, for picking up orders directly, can go to the counter 902 and pays the amount and picks up the ordered items. Customers can pick the items up at the ‘express’ lane or counter 902 for mobile orders.

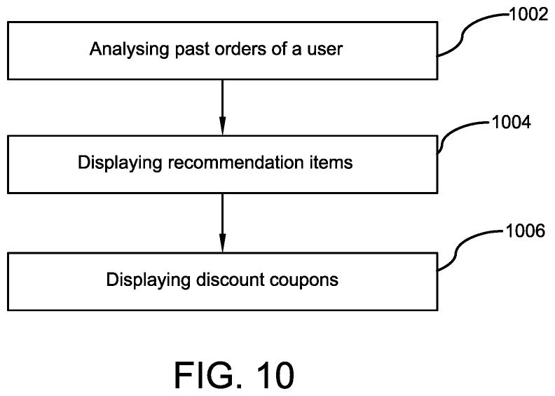

FIG. 10 illustrates a flow diagram depicting a process of displaying recommendations and coupons to the customers by the smartphone application in accordance with the disclosed architecture. The smartphone application 202 along with the controlling server 206 has built in artificial intelligence (AI) engine for analyzing past orders, favorite venues, and more of a user. The AI engine continuously analyzes past orders of users (Step 1002). Then, based on the analysis of the past orders, venues and more, menu items and concession stands are recommended to the user for purchase (Step 1004). Once, one or more items are selected by the user, then, discount coupons are displayed by the system for enabling the user to purchase items using the application (Step 1006).

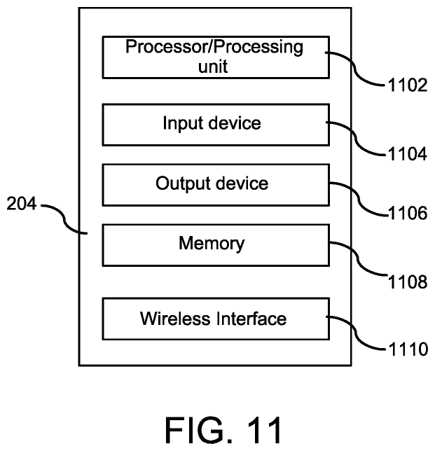

FIG. 11 illustrates the exemplary user device 204 that is used for installing the software application 202 of the present invention in accordance with the disclosed architecture. The processing unit 1102 can include suitable logic, instructions, circuitry, interfaces, and/or codes for executing various operations, such as the operations associated with the user device 204, or the like. The processing unit 1102 can be configured to control one or more operations executed by the electronic device 204 in response to the input received at the device 204 from the user. The processor 1102 executes the computer readable instructions stored in the application 202. Examples of the processing unit 1102 can include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), and the like. The electronic device 204 can further include one or more computer executable applications configured to be executed by the processing unit 1102. The one or more computer executable applications can include suitable logic, instructions, and/or codes for executing various operations. The one or more computer executable applications can be stored in the memory 1108.

The user device 204 includes input device(s) 1104 such as a touch input device, voice input device, etc. for entering data and information. Preferably, the touch interface of the user device 102 is used as the input and various buttons/tabs shown on the application 202 are pressed or clicked by the user. Other input devices such as camera and microphone are used during video chatting by the user. The display of the user device 204 also acts as the output device 1106 for displaying various contents (i.e., text, images, videos, icons, and/or symbols, etc.) to the user. The display can include a touch screen, and can receive, for example, a touch, gesture, proximity, or hovering input using an electronic pen or a part of a user's body.

Electronic device 204 has memory 1108 used for storing programs (sequences of instructions) or data (i.e., program state information) on a temporary or permanent basis for use in the computer system. Memory 1108 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 1102, in combination with one or more of memory 1108, input device(s) 1104, output device(s) 1106 is utilized to provide users to execute instructions on the application 202. The connection to a network is provided by wireless interface 1110. The wireless interface 1110 enables the user device 204 to communicate with the server 206 and other components of the system 200.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “mobile concession stand application”, “smartphone application”, “software application”, and “application” are interchangeable and refer to the in-venue items ordering and delivery software application 202 of the present invention.

Notwithstanding the forgoing, the in-venue items ordering and delivery software application 202 of the present invention can be of any suitable configuration as is known in the art without affecting the overall concept of the invention, provided that it accomplishes the above-stated objectives. One of ordinary skill in the art will appreciate that the in-venue items ordering and delivery software application 202 as shown in the FIGS. is for illustrative purposes only, and that many configurations and functionalities of the in-venue items ordering and delivery software application 202 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of ordering concession items at a venue, the method comprising the steps of:
providing a concession ordering smartphone application;
registering a user ID and a password of a user;
inputting user credentials into said concession ordering smartphone application having said user ID and said password of the user;
receiving said credentials into said concession ordering smartphone application;
logging into said concession ordering smartphone application;
displaying a digital map of a plurality of concession stands positioned at the venue;
selecting one concession stand from said plurality of concession stands;
displaying a menu having a listing of products from said selected one concession stand;
selecting an order from said listing of products;
paying for said order;
placing electronically said order with said selected one concession stand; and
confirming said order with the user, wherein said displaying said digital map of said plurality of concession stands is based on a proximity of a user's seat section to said plurality of concession stands.

2. The method of ordering concession items of claim 1, wherein said displaying of said plurality of concession stands having a concession name, logo, and location.

3. The method of ordering concession items of claim 2, wherein said menu having said listing of products with pictures and prices of said listing of products.

4. The method of ordering concession items of claim 3, wherein said menu having a QR code for scanning and displaying said listing of products.

5. The method of ordering concession items of claim 4, wherein said paying for said selected product including a payment from a credit card.

6. The method of ordering concession items of claim 5 further comprising a step of displaying a real-time status of said order to the user.

7. The method of ordering concession items of claim 6 further comprising a step of delivering said order to said seat section of the user.

8. The method of ordering concession items of claim 6 further comprising a step of picking up said order at said selected one concession stand by the user.

9. The method of ordering concession items of claim 8, wherein said picking up said order at said selected one concession stand having an express line.

10. The method of ordering concession items of claim 9, wherein said displaying said digital map of said plurality of concession stands is based on a proximity of the user to said plurality of concession stands.

11. The method of ordering concession items of claim 10, wherein said smartphone is selected from a group consisting of a smartwatch, a tablet, and a PDA.

12. A method of ordering concession items at a venue, the method comprising the steps of:
providing a concession ordering smartphone application;
registering a user ID and a password of a user;
inputting user credentials into said concession ordering smartphone application having said user ID and said password of the user;
receiving said credentials into said concession ordering smartphone application;
logging into said concession ordering smartphone application;
displaying a digital map of a plurality of concession stands positioned at the venue;
selecting one concession stand from said plurality of concession stands;
displaying a menu having a listing of products from said selected one concession stand;
selecting an order from said listing of products;
paying for said order;
placing electronically said order with said selected one concession stand;
confirming said order with the user; and
selecting a choice of a delivery of said order from delivering said order to said seat section of the user and picking up said order at said selected one concession stand by the user, wherein said displaying said digital map of said plurality of concession stands is based on a proximity of a user's seat section to said plurality of concession stands.

13. The method of ordering concession items of claim 12, wherein said displaying of said plurality of concession stands having a concession name, a logo and a location.

14. The method of ordering concession items of claim 12, wherein said menu having said listing of products with pictures and prices of said listing of products.

15. The method of ordering concession items of claim 12, wherein said menu having a QR code for scanning and displaying said listing of products.

16. The method of ordering concession items of claim 12, wherein said paying for said selected product including a payment from a credit card.

17. The method of ordering concession items of claim 12 further comprising a step of displaying a real-time status of said order to the user.

18. A method of ordering concession items at a venue, the method comprising the steps of:
providing a concession ordering smartphone application;
registering a user ID and a password of a user;
inputting user credentials into said concession ordering smartphone application having said user ID and said password of the user;
receiving said credentials into said concession ordering smartphone application;
logging into said concession ordering smartphone application;
displaying a digital map of a plurality of concession stands positioned at the venue;
selecting one concession stand from said plurality of concession stands;
displaying a menu having a listing of products from said selected one concession stand;
selecting an order from said listing of products;
paying for said order;
placing electronically said order with said selected one concession stand;
confirming said order with the user; and
selecting a choice of a delivery of said order from delivering said order to said seat section of the user and picking up said order at said selected one concession stand by the user;
wherein said displaying said digital map of said plurality of concession stands is based on a proximity of the user to said plurality of concession stands; and
further wherein said digital map provides a navigation map for routing the user to said selected one concession stand.

19. The method of ordering concession items of claim 18, wherein said smartphone is selected from a group consisting of a smartwatch, a tablet and a PDA.

20. The method of ordering concession items of claim 19 further comprising a step of displaying a real-time status of said order to the user.
